(19) United States
(12) Patent Application Publication
(10) Pub. No.: US 2010/0298075 A1
(43) Pub. Date: Nov. 25, 2010

(54) GOAL MOUNTED SIGNAL

(75) Inventors: David L. Paslay, Moro, IL (US); Matthew M. Klarich, Greenville, IL (US)

Correspondence Address: SENNIGER POWERS LLP, 100 NORTH BROADWAY, 17TH FLOOR, ST LOUIS, MO, 63102, US

(73) Assignee: NEVCO, INC., Greenville, IL (US)

(21) Appl. No.: 12/785,673

(22) Filed: May 24, 2010

Related U.S. Application Data
(60) Provisional application No. 61/180,672, filed on May 22, 2009.

(51) Int. Cl. A63B 71/06; A63B 63/08; B23P 11/00; H01R 43/00

(52) U.S. Cl. 473/479; 29/428; 29/825; 116/202

(57) ABSTRACT

A basketball goal comprising: a frame; a transparent backboard mounted on the frame having a front face and a back face opposite the front face; a hoop mounted on the backboard and extending perpendicular to the front face of the backboard; an indicator strip mounted directly to the back face of the backboard, said strip including a plurality of light emitting diodes that are visible through the backboard; and a controller operatively connected to the indicator strip to selectively energize the light emitting diodes.

### CROSS REFERENCE TO RELATED APPLICATION

This application claims priority to U.S. Provisional Patent Application No. 61/180,672, which is hereby incorporated by reference in its entirety.

### BACKGROUND OF THE INVENTION

The present invention is directed to signals such as used at sporting events and, more particularly, to signals mounted on goals such as end of period lights mounted on basketball goals.

Some basketball rules permit end of period lights to be mounted on backboards. For example, the National Collegiate Athletic Association permits lights to be mounted along the margins behind transparent backboards to signal the end of a period of play. The lights may be no more than five inches from each backboard side edge, no more than six inches from the top edge, and should be even with the top of the hoop along the bottom margin.

As shown in FIG. 1, some current end of period light designs involve mounting brackets 10 positioned along the top, bottom, and side edges of the backboard B. The brackets 10 hold U-shaped channels 12. Each channel 12 has an open side facing a back face of the backboard B. Standoffs 14 extend from the bottom of the channel 12 toward the backboard B. Printed circuit boards 16 are mounted in the channel 12 on the standoffs 14. Light emitting diodes (LEDs) 18 are mounted on the printed circuit boards 16. A black guard plate 20 is mounted around the LEDs 18 to cover the printed circuit board 16, providing a contrasting background against which to view the end of period LEDs. The guard plates 20 also stabilize the LEDs so that they are less apt to be rendered inoperative due to vibrations caused by player and ball contact with the backboard B or with the light system.

Existing end of period light assemblies are subject to failure. In particular, the LEDs 18 leads can break due to contact or vibration, preventing the LEDs from lighting. Further, the guard plates 20 become dislodged and the brackets 10 fail due to direct contact or excessive vibration. In addition, the systems may only be used with backboards having particular configurations and are not suitable for retrofitting many backboard configurations.

### SUMMARY OF THE INVENTION

In one aspect, the present invention is directed to a basketball goal comprising: a frame; a transparent backboard mounted on the frame having a front face and a back face opposite the front face; a hoop mounted on the backboard and extending perpendicular to the front face of the backboard; an indicator strip mounted directly to the back face of the backboard, said strip including a plurality of light emitting diodes that are visible through the backboard; and a controller operatively connected to the indicator strip to selectively energize the light emitting diodes.

In another aspect, the present invention is directed to a method of mounting light signals on a basketball goal comprising: bonding a plurality of indicator strips directly to a back face of a transparent backboard forming a portion of the goal, each of said strips including a plurality of light emitting diodes; and electrically connecting each of said strips to a controller.

In another aspect, the present invention is directed to a goal comprising: a frame; a transparent member mounted on the frame; an indicator mounted directly on the member, said indicator including a light emitting diode that is visible through the transparent member; and a controller operatively connected to the indicator to selectively energize the light emitting diode.

In another aspect, the present invention is directed to a method of mounting a signal on a goal comprising: bonding a plurality of indicator strips directly to a back face of a transparent backboard forming a portion of the goal, each of said strips including a light emitting diode; electrically connecting each of said light emitting diode; and connecting a controller to the light emitting diode.

In another aspect, the present invention is directed to a method of mounting light signals on a basketball goal comprising: segmenting an indicator strip into a plurality of pieces, each piece having a plurality of light emitting diodes; attaching at least one of said plurality of pieces directly to a back face of a transparent backboard forming a portion of the goal; and electrically connecting each of said strips to a controller.

In another aspect, the present invention is directed to an end of period signal for mounting on a basketball goal comprising an indicator having a plurality of light emitting diodes, said indicator being formed to separate into a plurality of segments, each segment having a portion of said plurality of light emitting diodes.

Other objects and features will be in part apparent and in part pointed out hereinafter.

### BRIEF DESCRIPTION OF THE DRAWINGS

FIG. 1 is a side elevation in partial section of a conventional end of period light assembly;

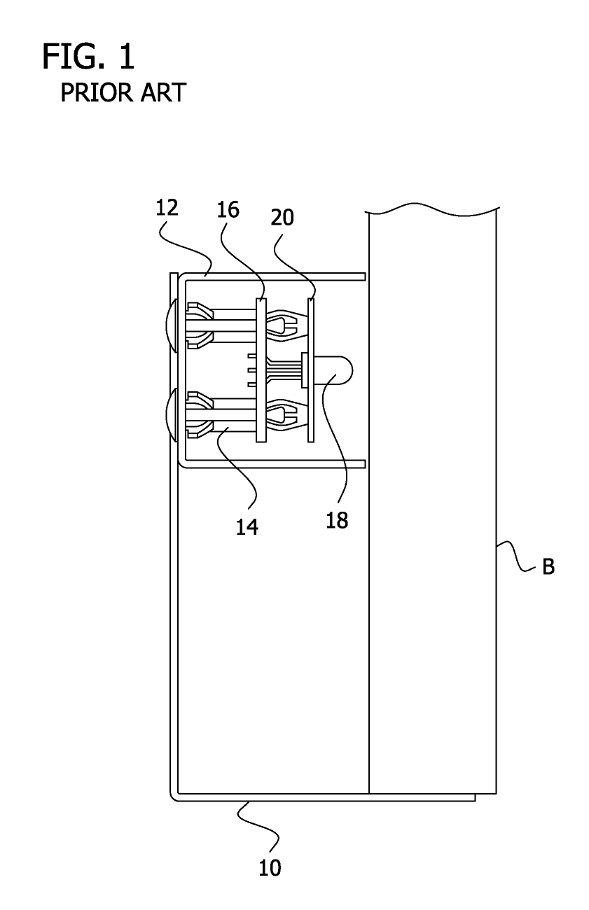

FIG. 2 is a front elevation of a basketball goal having end of period light assembly of the present invention;

FIG. 3 is a side elevation in partial section of the goal and end of period light assembly taken along line 3-3 of FIG. 2; and

FIG. 4 is a rear elevation of the end of period light assembly of the present invention.

Corresponding reference characters indicate corresponding parts throughout the drawings.

### DETAILED DESCRIPTION OF THE PREFERRED EMBODIMENTS

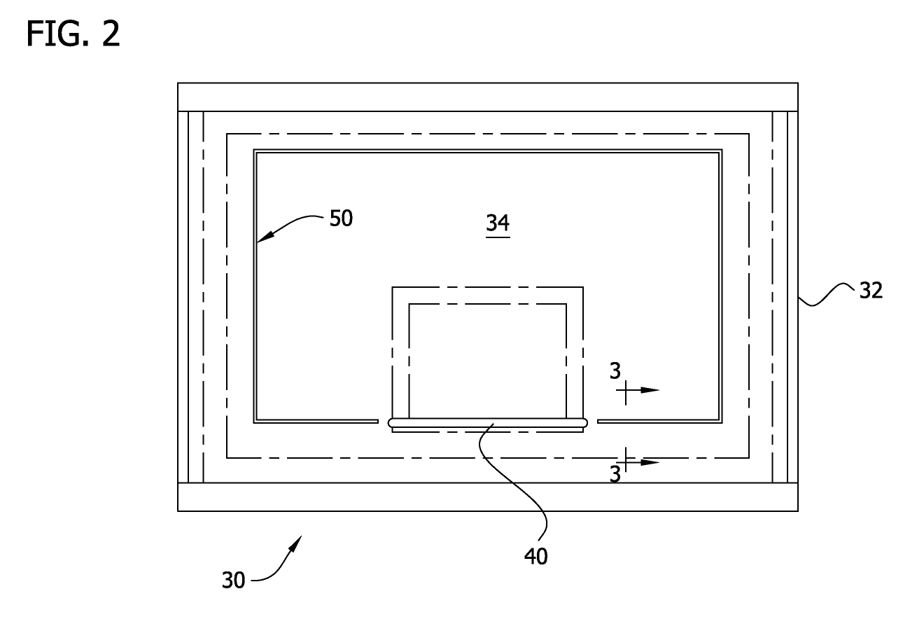

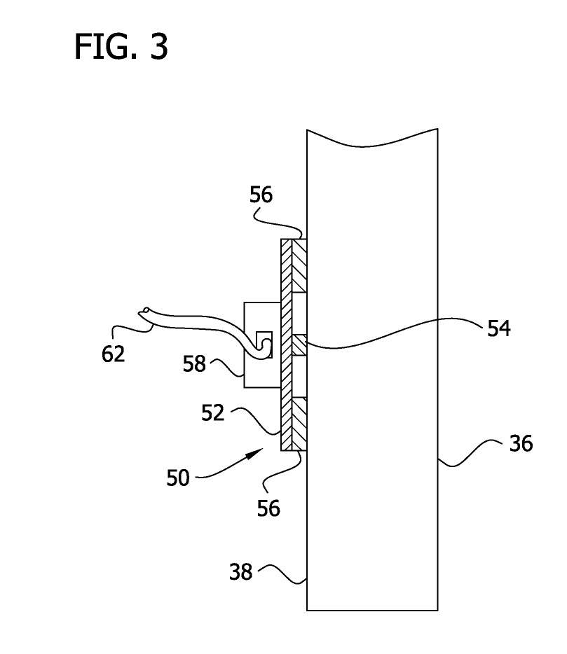

As illustrated in FIGS. 2 and 3, a basketball goal of the present invention is generally designated in its entirety by the reference character 30. The goal 30 includes a frame 32 and a transparent backboard 34 mounted on the frame. The backboard 34 has a front face 36 and a back face 38 opposite the front face. A hoop 40 is mounted on the backboard 34 such that it extends general perpendicular to the front face 36 of the backboard 34 and horizontal to the floor of the basketball court. As the above-described portion of the basketball goal 30 is conventional and well known in the art, the portion will not be described in further detail.

In addition to the conventional features of the basketball goal 30, a plurality of indicator strips, general designated 50, are mounted directly on the back face 38 of the backboard 34. As shown in FIG. 3, each strip 50 includes a printed circuit board 52 having a plurality of flush mounted light emitting diodes (LEDs) 54 mounted in a straight pattern along the circuit board. Although other LEDs may be used without departing from the scope of the present invention, in one embodiment the LEDs 54 are Part No. L955MEC-B/W-TR LED chips available from American Opto Plus LED Corp. of Pomona, Calif. The printed circuit board 52 is mounted on the back face 38 of the transparent backboard 34 by a suitable fastening means such as adhesive tape strips 56. In one embodiment, the tape strips 56 are double-sided foam tape. In some embodiments, both the adhesive tape strips 56 and the printed circuit boards 52 are black to be less intrusive visually when the LEDs 54 are not illuminated and to provide a visual contrast when the LEDs are illuminated. As will be appreciated by those skilled in the art, the light emitting diodes 54 are visible through the transparent backboard 34 when illuminated and are not readily visible when not illuminated. Electrical connectors 58 are provided on the circuit boards 52 for connecting the boards to a power source to energize the LEDs. As the circuitry on the circuit boards 52 may vary without departing from the scope of the present invention and the various configurations are well known to those skilled in the art, the circuitry will not be described in further detail. Some embodiments may have other configurations. For example, a flex circuit may be used in place of the circuit board. In other embodiments, the connectors may be omitted.

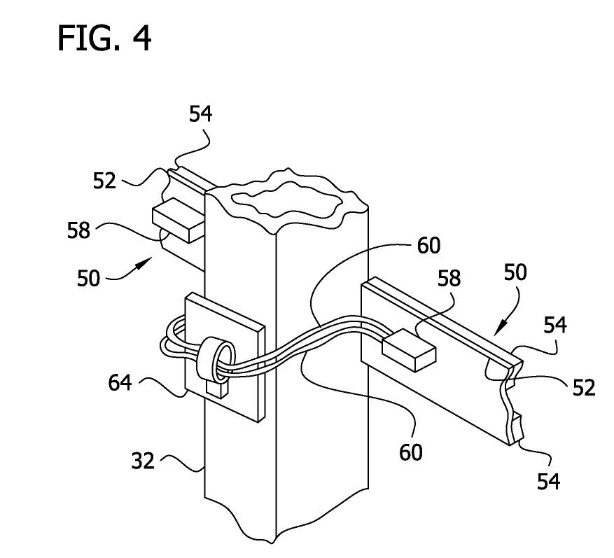

As shown in FIG. 2, in one embodiment the strips 50 are mounted in straight lines extending parallel to each side edge of the backboard 34 in conformance with recognized rules of play. Further, as illustrated in FIG. 4, jumper wires 60 are connected to the electrical connectors 58 of each adjacent pair of indicator strips 50 so the strips are ganged in series. Controller cables 62 are operatively connected to the ganged strips 50 to provide the strips with electricity to selectively energize the LEDs 54 such as at the end of a period of play. A controller (not shown) powers the controller cables 62. In one embodiment, the controller is a conventional controller such as an SCD-7 or SCD-T7 shot clock available from Nevco, Inc. of Greenville, Ill. The controller may be mounted adjacent to or remote from the backboard depending upon conditions of the particular installation. Supports 64 may also be used to support the wires 60 or cables 62 between the connectors 58.

In order to install the indicator strips 50, provisions must be made for avoiding frame members extending across the back face 38 of the backboard 34. In one embodiment, indicator strips of differing lengths are provided to accommodate these conditions. In some embodiments, the indicator strips are configured as shown so they may be cut into segments to provide strips having desired lengths. The indicator strips 50 may be installed on the backboard 34 when originally manufactured, or backboards in the field may be retrofitted using kits containing indicator strips as described above.

In addition to basketball goals, it is envisioned that the present invention may be adapted to goals used in other sports. Further, in addition to mounting lights, it is envisioned that the present invention may be adapted to other signals such as horns, buzzers, and sirens.

Having described the invention in detail, it will be apparent that modifications and variations are possible without departing from the scope of the invention defined in the appended claims.

When introducing elements of the present invention or the preferred embodiments(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

1. A basketball goal comprising:
a frame;
a transparent backboard mounted on the frame having a front face and a back face opposite the front face;
a hoop mounted on the backboard and extending perpendicular to the front face of the backboard;
an indicator strip mounted directly to the back face of the backboard, said strip including a plurality of light emitting diodes that are visible through the backboard; and
a controller operatively connected to the indicator strip to selectively energize the light emitting diodes.

2. A method of mounting light signals on a basketball goal comprising:
bonding a plurality of indicator strips directly to a back face of a transparent backboard forming a portion of the goal, each of said strips including a plurality of light emitting diodes; and
electrically connecting each of said strips to a controller.

3. A goal comprising:
a frame;
a transparent member mounted on the frame;
an indicator mounted directly on the member, said indicator including a light emitting diode that is visible through the transparent member; and
a controller operatively connected to the indicator to selectively energize the light emitting diode.

4. A method of mounting a signal on a goal comprising:
bonding a plurality of indicator strips directly to a back face of a transparent backboard forming a portion of the goal, each of said strips including a light emitting diode;
electrically connecting each of said light emitting diode; and
connecting a controller to the light emitting diode.

5. A method of mounting light signals on a basketball goal comprising:
segmenting an indicator strip into a plurality of pieces, each piece having a plurality of light emitting diodes;
attaching at least one of said plurality of pieces directly to a back face of a transparent backboard forming a portion of the goal; and
electrically connecting each of said strips to a controller.

6. An end of period signal for mounting on a basketball goal comprising an indicator having a plurality of light emitting diodes, said indicator being formed to separate into a plurality of segments, each segment having a portion of said plurality of light emitting diodes.
